(19) United States
(12) Patent Application Publication
(10) Pub. No.: US 2008/0041255 A1
(43) Pub. Date: Feb. 21, 2008

(54) PRINTING BLANKET HAVING A NON-EXTENSIBLE POROUS BACKING

(76) Inventor: Robert L. Andrew, Gastonia, NC (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/840,470

(22) Filed: Aug. 17, 2007

Related U.S. Application Data
(60) Provisional application No. 60/838,563, filed on Aug. 18, 2006.

(51) Int. Cl. B32B 3/24; B32B 3/10; B41F 13/10

(52) U.S. Cl. 101/376; 428/131; 428/304.4

(57) ABSTRACT

A printing blanket is provided having a porous non-extensible backing which allows moisture to pass out of the blanket during printing operations. The porous non-extensible backing ply may comprise a metal wire mesh, expanded metal, or a metal or polymer sheet having a plurality of apertures formed therein. The printing blanket is adhered to the first surface of the non-extensible backing ply and may include a compressible ply, a surface ply, and one or more reinforcing plies.

### CROSS-REFERENCE TO RELATED APPLICATIONS

This application claims the benefit of U.S. Provisional Application No. 60/838,563, filed Aug. 18, 2006, entitled PRINTING BLANKET HAVING A NON-EXTENSIBLE POROUS BACKING. The entire contents of said application are hereby incorporated by reference.

### BACKGROUND OF THE INVENTION

The present invention relates to a printing blanket, and more particularly, to a printing blanket having a non-extensible porous backing which allows moisture to pass out of the blanket during printing operations.

One of the most common commercial printing processes is offset lithography. In this printing process, ink is offset from a printing plate to a rubber-surfaced printing blanket mounted on a blanket cylinder before being transferred to a substrate, such as paper. Typically, the blanket cylinder comprises a chrome or nickel-plated steel cylinder having an encircling rubber printing blanket which is releasably mounted to the cylinder. The printing blanket may be reinforced with a number of fabric and/or rubber plies along with either a fabric or metal backing. The use of a metal backing is often preferable as it avoids stretching the blanket when it is mounted on the blanket cylinder. This provides better print quality and eliminates the need for frequent retensioning of the blanket as would be required with conventional fabric-backed blankets.

However, a common problem with the use of metal-backed blankets is the penetration of moisture into the plies of the printing blanket which occurs during the printing process. For example, water, inks and chemicals used during the printing process, as well as solvents used to wash and clean the printing blanket and/or press can infiltrate the blanket plies, causing swelling and delamination of the blanket layers. Because conventional metal blankets are nonporous, the moisture is often trapped and forms a “pool” internally in the blanket, which may adversely affect the performance and operational life of the blanket. A common method of trying to avoid this problem is to apply a sealant to the end edges and/or side edges of the blanket to prevent moisture from penetrating the layers. However, many sealants do not adhere well to the components used to construct the blanket, such as the rubber face, the compressible layer, adhesive layers, or the metal backing layer itself. Gaps and cracks resulting from poor adhesion may open, exposing the blanket layers to moisture infiltration.

Accordingly, there is still a need in the art for a printing blanket construction which prevents the build up of moisture into the layers of the blanket.

### SUMMARY OF THE INVENTION

The present invention meets that need by providing a printing blanket construction including a porous nonextensible backing ply which permits moisture to pass through the backing ply during printing operations, eliminating the build-up of moisture in the other blanket plies. By “non-extensible,” I mean that the dimensions of the backing ply do not change when conventional forces are encountered during normal mounting and operation of the blanket.

According to one aspect of the present invention, a printing blanket construction is provided comprising a porous non-extensible backing ply having first and second surfaces and a printing blanket including at least one ply, where the printing blanket is secured to the first surface of the non-extensible backing ply.

The printing blanket may include a compressible ply, a surface ply, and at least one reinforcing ply. The reinforcing ply may comprise fabric.

In one embodiment of the invention, the porous non-extensible backing ply comprises a metal wire mesh. In an alternative embodiment, the porous non-extensible backing ply comprises expanded metal. In another alternative embodiment, the backing comprises a sheet having a plurality of apertures formed therein. The sheet may be comprised of a metal, a polymer resin, or a reinforced polymer resin. Where the sheet is comprised of metal, the metal may comprise stainless steel.

The porous non-extensible backing ply has a thickness ranging from about 0.001 inches to about 0.02 inches (about 0.025 mm to about 0.51 mm).

The present invention also provides a method of making a printing blanket having a porous non-extensible backing comprising providing a non-extensible sheet, forming a plurality of apertures in the sheet, providing a printing blanket comprising at least one ply, and adhering the non-extensible backing to the printing blanket.

Alternatively, the method may comprise providing a non-extensible sheet having a plurality of apertures therein, providing a printing blanket comprising at least one ply, and adhering the non-extensible backing to the printing blanket.

The method may further comprise providing a non-extensible sheet, providing a printing blanket comprising at least one ply, adhering the non-extensible sheet to the printing blanket; and forming a plurality of apertures in the non-extensible sheet attached to the printing blanket.

Accordingly, it is a feature of the present invention to provide a printing blanket for use in offset lithographic printing applications including a porous non-extensible backing layer which prevents the buildup of moisture in the plies of the blanket. Other features and advantages of the invention will be apparent from the following description and the accompanying drawings.

### BRIEF DESCRIPTION OF THE DRAWINGS

FIG. 1 is a cross-sectional view of one embodiment of a printing blanket according to the present invention including a porous non-extensible backing;

FIG. 2 is a perspective view of an embodiment of a porous non-extensible backing for use in the printing blanket of the present invention;

FIG. 3 is a perspective view of another embodiment of a porous non-extensible backing for use in the printing blanket of the present invention; and

FIG. 4 is a schematic view of an embodiment of the printing blanket and backing mounted on a blanket cylinder.

### DETAILED DESCRIPTION OF THE PREFERRED EMBODIMENTS

Embodiments of the printing blanket of the present invention containing a porous non-extensible backing provide a number of advantages over prior metal or fabric backed blankets. Because the backing is comprised of a non-extensible material instead of fabric, it provides better print quality as it eliminates stretching and/or retensioning of the printing blanket during mounting and operation. And, by providing the backing with apertures such that the backing is porous, moisture which would otherwise accumulate in the blanket plies during printing operations is able to pass out of the blanket. While not wishing to be bound to any particular theory, it is believed that when the printing blanket is secured to a blanket cylinder and used in a printing operation, the porosity of the backing layer allows the blanket to act as a sponge during alternating compression and rebounding of the blanket such that moisture is squeezed out of the blanket and is not absorbed into the layers of the blanket.

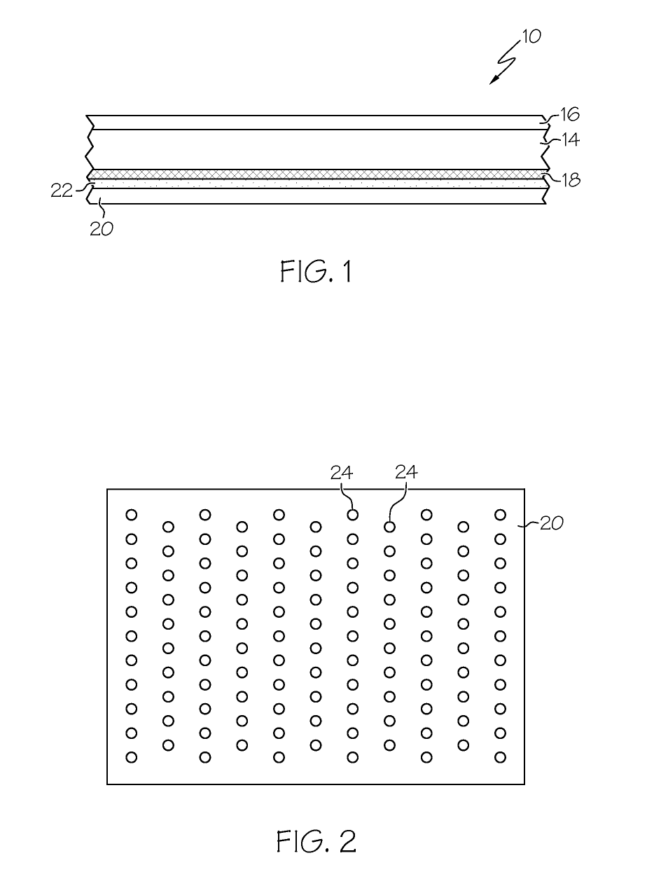

FIG. 1 illustrates a cross-sectional view of one embodiment of the printing blanket 10 of the present invention. The printing blanket preferably includes at least a compressible layer 14 and an outer surface layer 16 which acts to transfer an inked image from a printing plate to a substrate. Optionally, the blanket may include one or more reinforcing fabric layers such as fabric layer 18. As shown, the printing blanket is adhered to a porous non-extensible backing layer 20 with an adhesive 22. The adhesive used to adhere the blanket 10 and the backing layer 20 may comprise any of a number of conventional adhesives including hot melt adhesives, pressure sensitive adhesives, and curable rubbers.

FIG. 2 illustrates a perspective view of the porous non-extensible backing layer 20 which contains a number of apertures 24 therein to allow the passage of moisture. The apertures may be formed, for example, by electroforming a solid sheet of metal to provide apertures therein. A preferred metal for use as the backing layer is stainless steel. The apertures may be formed in conjunction with the fabrication of the backing ply, or the apertures may be formed after fabrication of the ply to render it porous to moisture. The apertures may be formed before or after the backing layer is adhered to the printing blanket and may be formed using conventional methods and tools commonly used to perforate materials.

It should be appreciated that the size, number, and spacing of the apertures are not important as long as moisture is able to pass out of the blanket during printing operations. However, a preferred size for the apertures is about 0.5 to about 2.5 mm., and the preferred number and spacing is about 20 to 200 apertures per square inch of blanket surface.

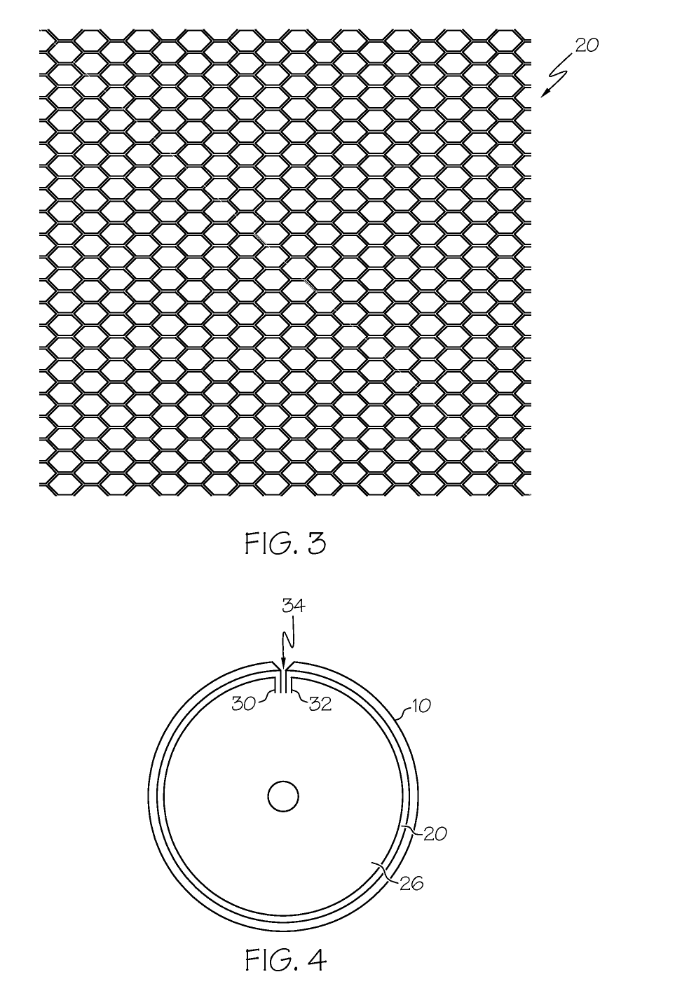

In an alternative embodiment illustrated in FIG. 3, the porous non-extensible backing layer 20 may be provided in the form of a wire mesh or expanded metal which already contains apertures therein.

The porous non-extensible backing layer preferably has a thickness ranging from about 0.001 inches to about 0.20 inches (about 0.025 mm to about 0.51 mm).

While in a preferred embodiment the porous backing layer has been described herein as being comprised of metal, it should be appreciated that other materials may be used as the backing layer as long as they possess the required characteristics of being non-extensible and porous to liquids encountered during a printing operation. Suitable materials which may be formed into a porous backing layer include polymeric resins or polymeric resins that have been reinforced with, for example, fiberglass, carbon, and aramid fibers.

In use, the printing blanket is mounted on a blanket cylinder 26 as shown in FIG. 4. The blanket 10 may be secured to the cylinder in a number of different ways. In the embodiment shown, the leading and trailing ends 30, 32 of the non-extensible backing layer 20 extend beyond the length of the other plies and are bent so that the ends are inserted into gap 34 to secure the blanket 10 to the blanket cylinder 26.

During printing operations, moisture from water, inks, or solvents may enter through the edges of the blanket as well as penetrating through the surface and backing layers of the blanket. However, rather than being absorbed and trapped inside the blanket, such moisture is able to pass out of the blanket. For example, moisture may be squeezed out of the blanket during the constant pumping action of the blanket as it is compressed and rebounds during printing. The moisture is forced out from the outer edges of the blanket, through the non-extensible porous backing, or through the trailing end of the blanket.

Having described the invention in detail and by reference to preferred embodiments thereof, it will be apparent that modifications and variations are possible without departing from the scope of the invention.

What is claimed is:

1. A printing blanket construction comprising a porous non-extensible backing ply having first and second surfaces and a printing blanket including at least one ply, wherein printing blanket is secured to said first surface of said non-extensible backing ply.

2. The printing blanket construction of claim 1 wherein said printing blanket includes a compressible ply.

3. The printing blanket construction of claim 1 wherein said printing blanket includes a surface ply.

4. The printing blanket construction of claim 1 wherein said printing blanket includes at least one reinforcing ply.

5. The printing blanket construction of claim 4 wherein said reinforcing ply comprises fabric.

6. The printing blanket construction of claim 1 wherein said porous non-extensible backing ply comprises a metal wire mesh.

7. The printing blanket construction of claim 1 wherein said porous non-extensible backing ply comprises expanded metal.

8. The printing blanket construction of claim 1 wherein said porous non-extensible backing ply comprises a sheet having a plurality of apertures formed therein.

9. The printing blanket construction of claim 8 wherein said sheet is comprised of a metal or a polymer resin.

10. The printing blanket construction of claim 8 wherein said sheet comprises a reinforced polymer resin.

11. The printing blanket construction of claim 8 wherein said metal comprises stainless steel.

12. The printing blanket construction of claim 1 wherein said porous non-extensible backing ply has a thickness from about 0.001 inches to about 0.20 inches.

13. A method of making a printing blanket having a porous non-extensible backing ply comprising:
providing a non-extensible sheet;
forming a plurality of apertures in said sheet;
providing a printing blanket comprising at least one ply; and
adhering said non-extensible sheet to said printing blanket.

14. The method of claim 13 wherein said non-extensible sheet comprises metal, a polymer resin, or a reinforcing polymer resin.

15. A method of making a printing blanket having a porous non-extensible backing ply comprising:
providing a non-extensible sheet;
providing a printing blanket comprising at least one ply; and
adhering said non-extensible sheet to said printing blanket; and
forming a plurality of apertures in said non-extensible sheet attached to said printing blanket.

16. The method of claim 15 wherein said non-extensible sheet comprises metal, a polymer resin, or a reinforced polymer resin.

17. A method of making a printing blanket having a porous non-extensible backing ply comprising:
providing a non-extensible sheet having a plurality of apertures therein;
providing a printing blanket comprising at least one ply; and
adhering said non-extensible sheet to said printing blanket.

18. The method of claim 17 wherein said non-extensible sheet comprises a wire mesh.
